(19) United States
(12) Patent Application Publication
(10) Pub. No.: US 2019/0132386 A1
(43) Pub. Date: May 2, 2019

(54) User-Device Based E-Commerce Server

(71) Applicant: TENSERA NETWORKS LTD., Hod Hasharon (IL)

(72) Inventors: Daniel Yellin, Raanana (IL); Shimon Moshavi, Beit Shemesh (IL)

(21) Appl. No.: 16/090,828

(22) PCT Filed: May 25, 2017
(86) PCT No.: PCT/IB2017/053080

§ 371 Date: Oct. 3, 2018

Related U.S. Application Data
(60) Provisional application No. 62/345,807, filed on Jun. 5, 2016.
(60) Provisional application No. 62/412,864, filed on Oct. 26, 2016.
(60) Provisional application No. 62/418,803, filed on Nov. 8, 2016.
(60) Provisional application No. 62/424,617, filed on Nov. 21, 2016.
(60) Provisional application No. 62/427,158, filed on Nov. 29, 2016.
(60) Provisional application No. 62/473,390, filed on Mar. 19, 2017.
(60) Provisional application No. 62/509,133, filed on May 21, 2017.

(51) Int. Cl. H04L 29/08; G06Q 30/06

(52) U.S. Cl. CPC H04L 67/1091; H04L 67/1095; G06Q 30/0641

(57) ABSTRACT

A user device (28) includes an interface and a processor (42). The interface is configured for communicating over a communication network (36, 40) with an electronic-commerce (“e-commerce”) server (24). The processor is configured to run within the user device a local instance (44) of the e-commerce server, wherein the local instance (i) stores locally in the user device at least part of data available to the e-commerce server, and (ii) carries out locally in the user device at least part of a business logic of the e-commerce server, to run an e-commerce agent (46), which conducts e-commerce transactions by interacting over the communication network with the e-commerce server, and locally with the local instance of the e-commerce server.

### CROSS-REFERENCE TO RELATED APPLICATIONS

This application claims the benefit of U.S. Provisional Patent Application 62/345,807, filed Jun. 5, 2016, U.S. Provisional Patent Application 62/418,803, filed Nov. 8, 2016, U.S. Provisional Patent Application 62/424,617, filed Nov. 21, 2016, U.S. Provisional Patent Application 62/412,864, filed Oct. 26, 2016, U.S. Provisional Patent Application 62/427,158, filed Nov. 29, 2016, U.S. Provisional Patent Application 62/473,390, filed Mar. 19, 2017, and U.S. Provisional Patent Application 62/509,133, filed May 21, 2017, whose disclosures are incorporated herein by reference.

### FIELD OF THE INVENTION

The present invention relates generally to communication systems, and particularly to methods and systems for performing electronic-commerce (“e-commerce”) transactions over communication networks.

### BACKGROUND OF THE INVENTION

Electronic commerce (“e-commerce”) is a term commonly used for describing the wide variety of applications and infrastructure relating to purchasing of products and services over the Internet. E-commerce transactions are typically client-server transactions, whereby users use their user devices to interact with vendors' e-commerce servers.

### SUMMARY OF THE INVENTION

An embodiment of the present invention that is described herein provides a user device including an interface and a processor. The interface is configured for communicating over a communication network with an electronic-commerce (“e-commerce”) server. The processor is configured to run within the user device a local instance of the e-commerce server, wherein the local instance (i) stores locally in the user device at least part of data available to the e-commerce server, and (ii) carries out locally in the user device at least part of a business logic of the e-commerce server, to run an e-commerce agent, which conducts e-commerce transactions by interacting over the communication network with the e-commerce server, and locally with the local instance of the e-commerce server.

In some embodiments, the local instance is configured to carry out only part of the business logic of the e-commerce server, and to store locally only part of data available to the e-commerce server. In an embodiment, the e-commerce agent is configured to conduct the e-commerce transactions by communicating with the local instance of the e-commerce server, and the local instance is configured to communicate with the e-commerce server over the communication network when unable to respond locally to the e-commerce agent. In another embodiment, the e-commerce agent is configured to conduct the e-commerce transactions by communicating with the local instance of the e-commerce server, and to communicate with the e-commerce server over the communication network when unable to obtain information needed for the e-commerce transactions locally from the local instance.

In some embodiments, the processor is further configured to run a prefetch agent that prefetches selected portions of the data and of the business logic, so as to synchronize the local instance with the e-commerce server. In an example embodiment, the prefetch agent is configured to receive from a network-side node a prefetch policy, and to prefetch the selected portions of the data and of the business logic in accordance with the prefetch policy.

In some embodiments, the local instance of the e-commerce server is configured to choose, in accordance with a selection criterion, a partial subset of the data or business logic for storing locally in the user device. In some embodiments, the selection criterion chooses the partial subset of the data or business logic that (i) has a highest likelihood of being accessed, and (ii) does not exceed available resources of the user device. In an embodiment, the likelihood is calculated across all user devices. In another embodiment, the likelihood is calculated over a partial subset of all user devices. In yet another embodiment, the local instance is configured to choose, for a given e-commerce item, how much of the data associated with the given e-commerce item to obtain from the e-commerce server.

In another embodiment, the processor is configured to conduct at least part of the e-commerce transactions in absence of a communication link with the e-commerce server. In yet another embodiment, the e-commerce agent is configured to respond locally to a user search query, using the local instance. In an embodiment, the processor is configured to contact the e-commerce server for obtaining supplemental information relating to a result of the search query. In an embodiment, the local instance is configured to obtain, and store locally, one or more index files for performing user searches.

There is additionally provided, in accordance with an embodiment of the present invention, a system including a user device and a prefetch control subsystem. The user device is configured to run a local instance of an electronic-commerce (“e-commerce”) server, wherein the local instance (i) stores locally in the user device at least part of data available to the e-commerce server, and (ii) carries out locally in the user device at least part of a business logic of the e-commerce server. The user device is further configured to run an e-commerce agent, which conducts e-commerce transactions by interacting over a communication network with the e-commerce server, and locally with the local instance of the e-commerce server. The prefetch control subsystem is configured to select portions of the data and of the business logic of the e-commerce server, and to prefetch the selected portions to the user device for use by the local instance of the e-commerce server.

In some embodiments, the prefetch control subsystem is configured to provide a prefetch policy to the user device, and wherein the user device is configured to prefetch selected portions of the data and of the business logic in accordance with the prefetch policy. In some embodiments, the prefetch control subsystem is configured to cluster at least some e-commerce items of the e-commerce server into categories, and to assign to the e-commerce items respective access likelihood metrics per category, and wherein the user device is configured to conduct the e-commerce transactions in accordance with the access likelihood metrics.

There is further provided, in accordance with an embodiment of the present invention, a method including running within a user device a local instance of an electronic-commerce (“e-commerce”) server. The local instance (i) stores locally in the user device at least part of data available to the e-commerce server, and (ii) carries out locally in the user device at least part of a business logic of the e-commerce server. E-commerce transactions are conducted in the user device, by running within the user device an e-commerce agent that interacts over a communication network with the e-commerce server, and locally with the local instance of the e-commerce server.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a communication system supporting e-commerce transactions, in accordance with an embodiment of the present invention; and

FIG. 2 is a block diagram that schematically illustrates a communication system supporting e-commerce transactions with prefetching, in accordance with an embodiment of the present invention.

### DETAILED DESCRIPTION OF EMBODIMENTS

### Overview

Electronic-commerce (“e-commerce”) transactions often involve complex interactions between the user device and the e-commerce server. In order to provide quality user experience, which in turn means high revenue to the e-commerce vendor, it is important to reduce communication delays to a minimum. Communication delay is especially problematic when the user device is wireless, particularly when the wireless link is cellular or when communication conditions are poor.

Embodiments of the present invention that are described herein provide improved methods and systems for conducting e-commerce transactions over communication networks. The disclosed techniques reduce the communication delays experienced by the user, by running a local instance of the e-commerce server within the user device.

The local instance of the e-commerce server (referred to herein as “local mini-server”) interacts with the e-commerce app or agent running in the user device, and with the remote full-fledged e-commerce server. During the e-commerce transactions conducted by the e-commerce app or agent, at least part of the business logic of the e-commerce server is actually performed by the local instance. As such, at least part of the client-server communication is actually performed locally within the user device, not across the network.

Consequently, e-commerce transactions can be conducted with considerably smaller communication delays, and thus with enhanced smoothness and better user experience. Moreover, since the e-commerce server business logic is delegated, at least partially, to the user devices, the disclosed techniques improve the scalability of the e-commerce system.

### E-Commerce System Description

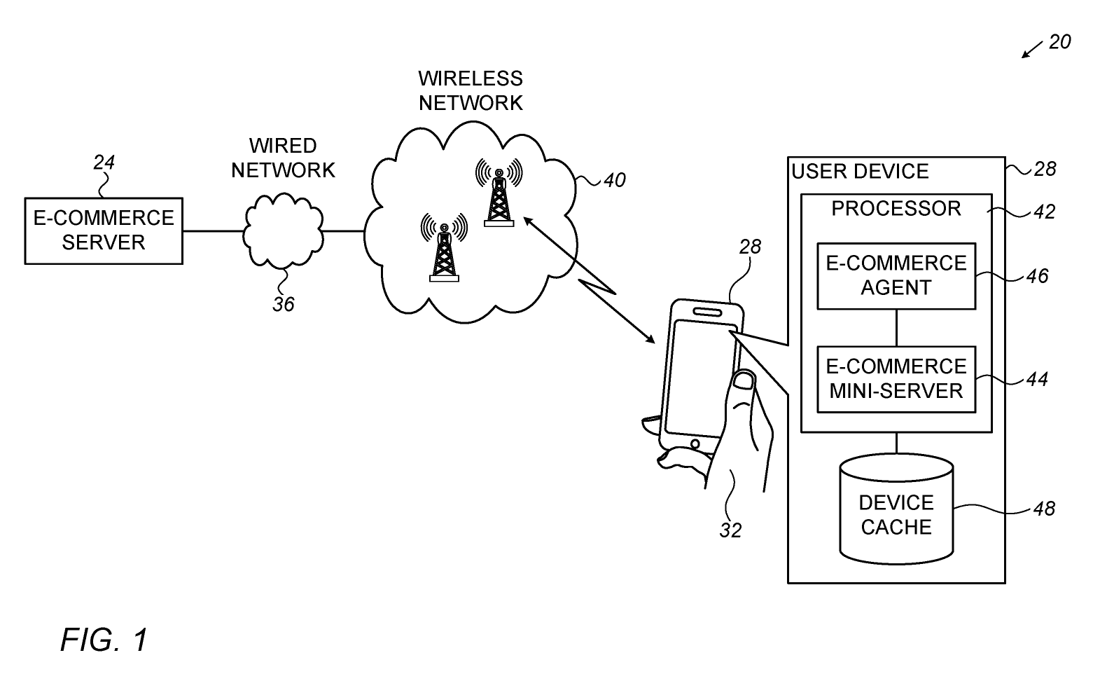

FIG. 1 is a block diagram that schematically illustrates a communication system 20 supporting e-commerce transactions, in accordance with an embodiment of the present invention. In the present example, system 20 comprises an e-commerce server 24 that provides e-commerce services to user devices 28 operated by users 32. Although the embodiments described herein refer mainly to wireless networks, the disclosed techniques can also be used in various wired networks.

E-commerce server 24 may comprise, for example, a Web-site of some e-commerce vendor. In a typical non-limiting example, server 24 enables user devices 28 to browse through an inventory catalog, query pricing and product details, view special offers, perform various searches and queries, inquire re physical store or office opening times and locations, make purchases, track order status, and/or perform any other suitable interaction. Any and all such interactions between user device 28 and server 24 is referred to herein as “e-commerce transactions” or simply “transactions” for brevity.

E-commerce server 24 may comprise any suitable computing platform or combination of computing platforms. User devices 28 may comprise, for example, cellular phones, smartphones, tablet computers, laptop computers, wearables, mobile car devices, or any other suitable device that is capable of interacting with e-commerce server 24 and conducting e-commerce transactions. FIG. 1 shows only one user device 28 and one e-commerce server 24 for the sake of clarity. Real-life implementations, however, typically comprise a large number of user devices 28 and possibly multiple servers 24.

The various elements of system 20, e.g., e-commerce server 24 and user devices 28, communicate with one another over one or more wired or wireless communication networks. In the present example, server 24 is accessed over a wired network 36 (e.g., the Internet and/or a Local Area Network—LAN) that is connected to a wireless network 40 (e.g., a cellular or Wi-Fi network) that serves user devices 28. The end-to-end content paths from the e-commerce server to the user devices therefore typically traverse both wired and wireless links. In the present context, the network or combination of wireline and/or wireless networks over which user devices 28 interact with server 24 is referred to as “a communication network” or “a network.”

Each user device 28 typically comprises one or more suitable input/output devices for presenting content items to user 32 and for receiving user input, e.g., a touch screen. In addition, each user device 28 comprises suitable radio and baseband circuitry (not shown in the figure) that serves as an interface for communicating over network 40.

Each user device 28 further comprises a processor 42. Among other tasks, processor 42 runs an e-commerce agent 46 that interacts with user 32 and with server 24, so as to conduct the e-commerce transactions by the user. In one embodiment agent 46 comprises a general-purpose browser application. In another embodiment agent 46 comprises a dedicated application (“app”) for accessing a specific e-commerce server.

In the disclosed embodiments, processor 42 also runs a local instance 44 of e-commerce server 24. Local instance 44 is also referred to herein as “mini-server,” and is used for reducing communication delays, improving performance and enhancing user experience when conducting e-commerce transactions. The structure, functionality and usage of mini-server 44 are addressed in detail below. Each user device 28 additionally comprises a respective device cache 48 for temporarily storing relevant information for agent 46 and mini-server 44.

### Enhanced E-Commerce Transactions Using Local Mini-Server

In many practical cases, an e-commerce transaction involves a large number of data-intensive interactions between user device 28 and e-commerce server 24. Any communication delay along the link between the user device and the e-commerce server may degrade the performance and user experience of the transaction. In some embodiments, the use of local instance 44 of the e-commerce server (“mini-server”) helps to reduce such delays.

Typically, mini-server 44 carries out at least part of the business logic of server 24. When conducting an e-commerce transaction, some or even all of the interaction of e-commerce agent 46 is performed with mini-server 44 (locally within the user terminal) instead of with server 24 (over the network).

It is important to note that the operation of mini-server 44 goes far beyond caching of data that is normally found on server 24 (although in some embodiments data caching is also performed). Rather, mini-server 44 performs at least part of the functionality of server 24, e.g., at least part of a state-machine model or rule engine that implements the e-commerce server business logic.

In some embodiments, when unable to respond locally to e-commerce agent 46, mini-server 44 contacts server 24 to obtain the missing information (e.g., e-commerce data and/or business logic). In other embodiments, e-commerce agent 46 contacts server 24 for obtaining missing information that mini-server 44 is unable to provide.

In one example embodiment, e-commerce agent 46 carries out an entire e-commerce transaction, from initial access to the server until payment, by communicating with mini-server 44 instead of with e-commerce server 24. In an embodiment, although not necessarily, the entire transaction may be carried out while no communication link is available between user device 28 and server 24. At some later time, mini-server 44 notifies server 24 of the transaction, so as to process the transaction and maintain consistency. In other embodiments, in the course of an e-commerce transaction, e-commerce agent 46 communicates with mini-server 44 when possible, and with server 24 when needed.

In various embodiments, mini-server 44 may provide various elements of business logic, conventionally provided by e-commerce server 24. Such elements of business logic may comprise, for example:
An inventory catalog of at least some of the products and/or services offered by e-commerce server 24. The catalog may comprise inventory status, e.g., “in-stock” or “out-of-stock” indications, and/or estimated delivery times.
Price-related information, possibly including special offers. Some special offers or other price-related information may be personalized to the specific user. Some price-related information may vary with time, with location, or with any other suitable parameter.
Infrastructure for performing searches, e.g., backend inventory databases, index files for efficient access to databases.
Check-out forms and supporting screens. Schemes for handling interactive content, e.g., as described in U.S. Provisional Patent Application 62/473,390, cited above, can be used for this purpose.
Payment-related functions, e.g., credit-card processing and confirmation.

In addition, in some embodiments, mini-server 44 may provide agent 46 with access to data or data structures that are conventionally found on e-commerce server 24. Such data may comprise, for example:
Product/service specifications or other detailed description or information regarding the products and/or services offered by server 24. Product images. Product ratings and/or reviews.
Locations and/or opening times of physical stores or offices.

In some embodiments, e-commerce agent 46 requests any data or functionality it needs from mini-server 44. If mini-server 44 is able to respond to the request locally, it returns the requested data or functionality to agent 46. If not, mini-server 44 contacts e-commerce server 24 over the network in order to obtain the requested data or functionality. The latter communication incurs higher delay. Thus, in some embodiments, mini-server 44 supports locally the more frequently used data and/or functionality, so as to reduce the likelihood of having to contact server 24.

In various embodiments, it is possible to apply various criteria in selecting the subset of data and/or functionality of server 24 that will be supported by mini-server 44. The criteria may consider, for example, the computational power needed for processing the data or functionality at the user device, the required data transfer size, required storage size in cache 48, and/or any other suitable factor.

For example, in one embodiment, index files that support fast search functionality for large product databases are constructed and updated in e-commerce server 24, since they typically require substantial computational power to construct. In these embodiments, the index files may be created by server 24, transferred from server 24 to mini-server 44, and queried locally by agent 46. In other embodiments, it is possible to create the index files locally by mini-server 44.

In some embodiments, mini-server 44 is implemented as a separate server running on processor 42 of user device 28. In other embodiments, mini-server 44 may be embedded in e-commerce agent 46, e.g., in an e-commerce app running on processor 42. In other embodiments, mini-server 44 may be implemented as a Software Development Kit (SDK) embedded in an app (e.g., in agent 46) or as part of the user device Operating System (OS). In another embodiment, user device 28 may run a proxy server, which interacts with and serves one or more e-commerce agents 46 (typically associated with different e-commerce vendors) and is exposed to incoming and outgoing traffic. In other embodiments, mini-server 44 may be implemented as a browser extension running on processor 42. Further alternatively, any other suitable implementation can be used.

### Integration of E-Commerce with Prefetch

In many practical cases, the business logic and data used by e-commerce server 24 varies considerably over time. For example, inventory status may change, and special offers may appear or end. In order to perform well, mini-server 44 in user device 28 should be synchronized to these updates. As with the e-commerce transactions themselves, updating the data and/or functionality of mini-server 44 incurs delays, since it involves communication with e-commerce server 24 over the network. Delays may be acute for user devices that are connected to the network via wireless links, e.g., when channel conditions are poor.

In some embodiments, prefetching techniques can be used for eliminating or reducing at least some of the delays that potentially degrade the user experience when conducting e-commerce transactions. Example prefetching techniques that can be used for this purpose are addressed in U.S. Patent Application Publication 2016/0021211, entitled “Efficient content delivery over wireless networks using guaranteed prefetching at selected times-of-day,” which is assigned to the assignee of the present patent application and whose disclosure is incorporated herein by reference.

In some embodiments, mini-server 44 prefetches updated versions of the business logic and/or data from e-commerce server 24 so as to remain constantly synchronized. In an embodiment, the updates may be provided at selected times, for example times in which network congestion is low, times at which a broadband link is available, times at which a low-cost link is available, times at which the user device battery is full, times at which connection is available with low power consumption, or at any other suitable times.

In the present context, the term “prefetching data and/or business logic” means that selected data and/or portions of the e-server's business logic are delivered to mini-server 44 before they are actually required by a specific e-commerce transaction.

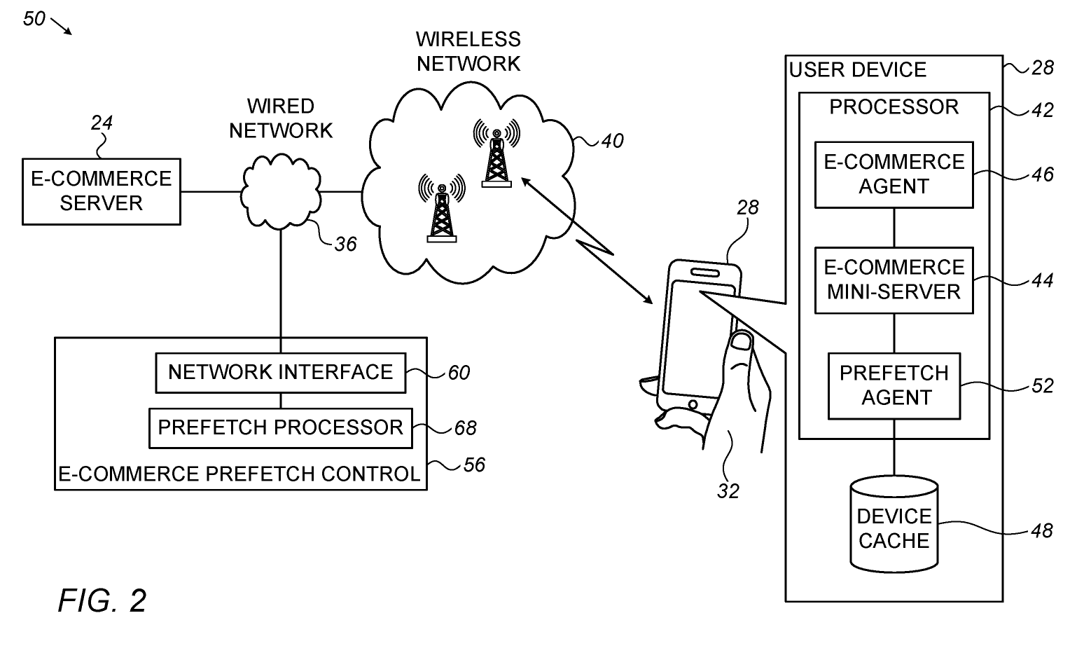

FIG. 2 is a block diagram that schematically illustrates a communication system 50 supporting e-commerce transactions with prefetching, in accordance with an embodiment of the present invention. In this embodiment, in addition to e-commerce agent 46, processor 42 of user device also runs a prefetch agent 52 that carries out prefetching functions on the user-device side.

In addition, the network side comprises an e-commerce prefetch control (EPC) subsystem 56, referred to herein simply as “EPC” for brevity. EPC 56 comprises a network interface 60 for communicating with network 36, and a prefetch processor 68 that carries out the prefetching control functions of the EPC.

Typically, processor 68 sets the applicable prefetch policy, which assists the user device in determining which e-commerce data and/or business logic should be prefetched from server 24 to mini-server 44 and when it should be prefetched. Processor 68 typically also detects changes in the data and/or business logic of server 24, which may trigger prefetching.

In some embodiments, as shown in FIG. 2, EPC 56 is implemented as a server connected to the network. In alternative embodiments, the functionality of EPC 56 may be implemented in user device 28.

In various embodiments, any part of the data and/or business logic of e-commerce server 24 may be prefetched to mini-server 44 (e.g., product databases, inventory status, prices and special offers, to name just a few examples). Additionally or alternatively, search index files created in server 24 may be prefetched to mini-server 44, for use in speeding-up local searches conducted by e-commerce agent 46. In another embodiment, the index files can be created in user device 28 based on the databases that have been pre-fetched.

Setting of the prefetch policy by processor 68 may comprise estimating the likelihood that user 32 will request to carry out an e-commerce transaction with a particular e-commerce vendor. Processor 68 may send to user device 28 a metric indicative of this likelihood, in order to assist agent 52 to decide on prefetch priorities for the corresponding e-commerce data. The likelihood estimation may take into account various parameters. Some parameters may be user-related, such as, for example, gender, location, interests, recent and historical e-commerce activity. Other parameters may be environment-related, such as, for example, time-of-day, road traffic conditions, weather, current events, sporting occasions, and others. Yet other parameters may be e-commerce-vendor related, such as, for example, the vendor identity, special offers, current and historical popularity of the vendor, and other parameters. Further additionally or alternatively, processor 68 may use any other suitable parameters in estimating the likelihood metrics.

In some embodiments, the likelihood of accessing certain information (e.g., e-commerce data or business logic) is calculated across all user devices in the system. In other embodiments, the likelihood is calculated in some personalized manner, e.g., per a specific user device or group of user devices, or conditioned on some parameter.

In some embodiments, processor 68 estimates the time the user is likely to access e-commerce data in order to help determine the prefetch priorities of the various e-commerce data and/or the timing of the prefetch. These time estimates might be separately specified as part of the prefetch policy sent to the user device, or they might be incorporated into likelihood metrics themselves. For example, e-commerce data that is likely to be accessed within the next hour might be given a higher likelihood metric than e-commerce data that will not be needed for at least two hours.

In some embodiments, processor 68 clusters the data used for supporting e-commerce into multiple categories. Processor 68 may enable updating of data associated with a certain category without having to update data of other categories. For example, categories may relate to different product types. In an example implementation, an e-commerce vendor may have one data cluster associated with books, another cluster associated with clothing, and so on. Processor 68 of ECP 56 may provide separate likelihood metrics in the prefetch policy for each category. Thus, for example, users 32 who never ordered clothing from this vendor may receive a low prefetch likelihood metric for clothing data, but may have a high likelihood metric for book-related data. The likelihood metrics associated with each data category may be included in the prefetch policy sent to the user device. This technique enables prefetch decisions that are optimized per data category, a feature that helps reduce the overall data cost of prefetch operations.

In various embodiments, processor 68 may define the product categories for prefetching as narrowly or as broadly as desired. In some embodiments, processor 68 may specify and send to user device 28 a separate likelihood metric for each data item available in server 24. In this context, the term “data item” refers to any suitable unit of data, from a single product to a broad category of products.

Additionally or alternatively to the likelihood metrics, processor 68 may set the prefetch policy based on additional factors. One factor may comprise power consumption, e.g., a policy that prefers to perform prefetch while Wi-Fi connection or a strong cellular connection is available. Another possible factor may comprise the transmit cost, e.g., a policy that prefers to perform prefetching at times having lower data-transfer cost. Another factor might relate to the battery level at the device. Other factors may comprise the current network congestion and server load (e.g., a policy that prefers to prefetch during off-peak traffic hours), data size (the amount of data needed to update mini-server 44), and/or any other suitable user, user device, data, vendor, or network related factors.

In some embodiments, in order to maintain mini-server 44 synchronized with server 24, processor 68 of ECP 56 may track e-commerce server 24 and generate an associated catalog of data items. In such a catalog, each data item may be represented by a respective identifier (ID) along with an indication of its version number, in order to keep track of which items have changed. The catalog may also comprise the likelihood metrics described above, and/or links or addresses from which the data items can be retrieved. In the present context, the prefetch catalog is regarded part of the prefetch policy, along with any other prefetch rules, strategies and thresholds that may be defined by processor 68.

In an embodiment, upon deciding that a certain change in server 24 (e.g., to the prefetch policy and/or to a previously prefetched data item) is significant for a particular user device 28, processor 68 may notify prefetch agent 52 of this user device of the change. This notification is referred to herein as a Prefetch Notification (PN). Processor 68 may report PNs to user devices 28 using any suitable reporting scheme. Two non-limiting examples are Google Cloud Messaging (GCM) used in Android devices and Apple Push Notification (APN) used for iOS devices.

In an embodiment, prefetch agent 52 in a given user device 28 may request and receive an updated prefetch policy from processor 68. Agent 52 can then decide whether to issue a prefetch request based on this policy and various relevant factors regarding its current state. Such factors may comprise, for example, battery level, network connection quality, data items already residing in cache 48, and many others. The actual prefetching operation may be carried out via processor 68, or directly from server 24. Upon receiving the prefetched data item, agent 52 typically stores the data item in cache 48 and updates mini-server 44.

In an example embodiment, prefetch agent 52 may receive an e-commerce access request from user 32 (e.g., via mini-server 44 or e-commerce agent 46). Prefetch agent 52 determines whether the requested data already resides in cache 48. If so, agent 52 retrieves the data from cache 48 and serves the data in response to the request. Otherwise, agent 52 retrieves the data in question over the network from server 24. In an embodiment, prefetch agent 52 may also send reports to processor 68 in EPC 56, to enable processor 68 to track historical e-commerce usage patterns and other relevant information related to the user or the network that can be used as inputs for setting the prefetch policy.

In some embodiments, the prefetch policy comprises a validity time, which specified how long a prefetched data item is valid for. In these embodiments, if user 32 accesses an e-commerce data item that has been prefetched but whose validity time has expired, prefetch agent 52 may decide to fetch the data item from server 24 over the network.

In some embodiments, prefetch agent 52 may retrieve a prefetched data item from cache 48 and present it to the user, and in parallel issue a request to processor 68 to check whether the cached data item is sufficiently up-to-date. If the data item is not sufficiently up-to-date, then an updated data item may be fetched and presented to the user as soon as it is ready. Techniques of this sort are addressed, for example, in U.S. Patent Application Publication 2016/0021211, cited above, and in U.S. Patent Application Publication 2017/0111465, entitled “Freshness-aware presentation of content in communication terminals,” which is assigned to the assignee of the present patent application and whose disclosure is incorporated herein by reference.

In some embodiments, prefetch agent 52 is embedded in an app running on processor 42. In other embodiments, agent 52 may be implemented as a Software Development Kit (SDK) embedded in an app or as part of the user device Operating System (OS). In another embodiment, user device 28 may run a proxy server, which is controlled by agent 52 and is exposed to incoming and outgoing traffic. In another embodiment, a prefetch agent 52 that is implemented as a proxy server, can support multiple mini-servers 44 and/or multiple e-commerce agents 46. In other embodiments, the prefetch agent 52 may be implemented as a browser extension in the user device. Further alternatively, the functionality of prefetch agent 52 may be implemented entirely on the network side without a prefetch agent on the user device. Further alternatively, any other suitable implementation can be used.

In some embodiments, processor 68 in ECP 56 sends to user devices 28 automatic (i.e., unsolicited) updates of e-commerce data items and/or prefetch policy. In some embodiments, processor 68 sends at least some the updates embedded in Prefetch Notifications (PNs). Techniques of this sort are addressed, for example, in U.S. patent application Ser. No. 15/404,214, entitled “Efficient prefetch notifications,” which is assigned to the assignee of the present patent application and whose disclosure is incorporated herein by reference.

In some embodiments, processor 68 is configured to track changes in e-commerce server 24 with a certain update rate. The update rate may be set, for example, based on an observed change pattern exhibited over time by server 24.

In some embodiments, processor 68 compresses the data items, so that they can be prefetched more efficiently to the user device. For example, processor 68 may identify and send only changes to the e-commerce data since the most-recent prefetch operation. This technique enables efficient prefetch operation that minimizes data usage and power consumption.

In some embodiments, the functionality of EPC 56 can be implemented in e-commerce server 24 and integrated with the other e-commerce capabilities of the server. In these embodiments, server 24 is immediately aware of any changes to the e-commerce data items. Server 24 can thus notify user devices 28 directly of relevant changes.

In alternative embodiment, the functions of e-commerce server 24, e-commerce agent 46, mini-server 44, EPC 56 and prefetch agent 52, may be partitioned or grouped in any suitable way. For example, the functionality of e-commerce server 24 and EPC 56 may be combined to form an enhanced e-commerce server. In other embodiments, min-server 44 and prefetch agent 52 can be combined to form an enhanced mini-server. In yet other embodiments, the functions of e-commerce agent 46, mini-server 44 and prefetch agent 52 can all be combined to form an enhanced e-commerce agent.

In some embodiments, system 50 may support additional prefetching operational modes. One such mode is a “push” prefetching mode, in which e-commerce server 24 may push data directly to mini-server 44 in user device 28 when important updates become available. Another possible mode is a “Just-in-Time” (JIT) prefetching mode, in which prefetch agent 52 may retrieve updates for mini-server 44 when user 32 accesses e-commerce agent 46. In this mode, the update occurs only when the user has already started accessing the e-commerce application.

In some embodiments, system 50 uses different prefetch modes for different types of e-commerce data. For example, certain types of e-commerce data may be transferred using full prefetch techniques, such as the techniques described herein. Other types of data may be directly pushed from e-commerce server 24 as they become available, or transferred to mini-server 44 using the JIT mode.

### Optimizing the Local Instance of the E-Commerce Server

In most practical cases, e-commerce server 24 is far too large and complex for mini-server 44 to encompass its entire contents and business logic. The limitations may be due to the size of cache 48 and/or the computational power of processor 42, for example. Thus, in some embodiments, mini-server 44 chooses only a selected subset of the data and/or business logic of server 24, and stores the selected subset locally in cache 48. Various selection criteria can be used for this purpose. Typically, the subset is selected to maximize the likelihood that the data or business logic actually needed by the user will be found locally in mini-server 44, without exceeding the limited resources of user device 28. Examples of constraints on user-device resources comprise memory constraints, power (battery life) constraints, processing (CPU) constraints, and/or data transfer constraints.

In various embodiments, mini-server 44 may be optimized in various ways to support the most relevant data and business logic. In an embodiment, the optimization is decided by mini-server 44, which in turn retrieves the data items of interest from server 24. In a typical embodiment, mini-server 44 makes the optimization decisions based on inputs such as the prefetch policy, user-device status and/or user configuration inputs.

In some embodiments, mini-server 44 stores in cache 48 the N most popular data items that have been accessed by the various users of e-commerce server 24. The N most popular data items may be conditioned on a certain parameter, such as the age group or gender of the user.

In another embodiment, mini-server 44 stores in cache 48 the N data items that the user will most likely access. Mini-server 44 may perform this prediction, for example, using a machine learning process that takes into account various user-specific features (such as past e-commerce activity), possibly in addition to features related to other users (such as general popularity across all users). In another embodiment, mini-server 44 stores in cache 48 only data items that have a customer rating above a certain threshold. The threshold may be fixed, or it may be set, for example, by the user.

In yet another embodiment, mini-server 44 stores in cache 48 data items belonging to categories that are regarded as relevant to the specific user. For example, a user device that uses a certain e-commerce server to purchase only books may have only book-related product data stored locally in its cache 48. Similarly, if this user purchases sports books almost exclusively, then only data items associated with sports books may be stored locally in cache 48.

In other embodiments, mini-server 44 automatically optimizes the number of data items and/or the size of the data stored in cache 48, based on the memory limitations of the user device. Additionally, user 32 may define limits on the number of content items or the size of the data being stored in cache 48 for mini-server 44. In an embodiment, user 32 may define various criteria for choosing which items to store locally in cache 48, such as key words, categories, brands, price range, and others.

In some embodiments, for a certain e-commerce data item (e.g., product), mini-server 44 stores only a subset of the data supporting this item locally. Other data supporting the item has to be retrieved from server 24 when needed. For example, mini-server 44 may store images and prices for certain items, but not user reviews. In some embodiments, the type and amount of data stored locally for each item is determined based on the likelihood that the user will access them (e.g., with metrics calculated using machine learning).

Thus, in an embodiment, items having very high probability of being accessed will have all their associated data stored locally in cache 48. Items that are less likely to be accessed, on the other hand, will have less data stored locally for mini-server 44. The types of data stored locally can also be optimized for each item, e.g., based on user-related properties, item-related properties, and other factors. For example, if a particular user shopping for books always reads user reviews, then mini-server 44 may obtain the user reviews and store them locally in cache 48. On the other hand, if the user rarely reads user reviews when shopping for books, then the mini-server may not store user reviews locally. In some embodiments, the types of data stored locally can also be specified directly by the user.

In some embodiments, when e-commerce agent 46 performs a search over mini-server 44, agent 46 considers all items available in server 24. In other words, the full index files for searching are stored locally in user device 28, and are queried when searching. In other embodiments, the index files stored in user device 28 cover only items whose data is stored locally in cache 48. In these embodiments, only locally stored items may come up in search results.

In some embodiments, items whose data is available locally in mini-server 44 are provided quickly in response to a search, while items whose data is not available locally are provided more slowly because of the network access. In some embodiments, sufficient data for items to be displayed in a search response is stored locally for certain content items, while additional data is only available over the network. In this embodiment, these items will show up quickly in response to a user search, but if the user clicks on the items the additional associated details might take longer to display because of the network access. In an embodiment, additional associated details of at least some of the content items in the search response are transferred to the device after the user's search query but before the user clicks on the item, i.e., using “just-in-time” prefetch.

In some embodiments, mini-server 44 uses prefetch-related techniques for selecting which items to include as part of the subset catalog that is stored locally in cache 48. Example techniques are described in U.S. Patent Application Publication 2016/0021211, and in U.S. Provisional Patent Application 62/418,803, cited above. In these embodiments, mini-server 44 may compute likelihood metrics for the different items available in server 24, so as to predict which items the user is most likely to access (and possibly which types of supporting data will be needed). Mini-server 44 may use the likelihood metrics to determine which items/data to prefetch to user device 28. In some embodiments, the likelihood metrics are computed in a cloud application, e.g., based on machine learning, and then sent to the user device so that the final prefetch decisions can be made at the user device (and/or by the user).

In many practical cases, the data needed by mini-server 44 varies with time. Examples include prices, user ratings, inventory status and other data. Thus, the catalog entries and data associated with the subset of items should be kept up-to-date at the user device (i.e., synchronized with server 24). In some embodiments, the relevant subset of the catalog is retained up-to-date at the user device using the guaranteed prefetch mode described in U.S. Patent Application Publication 2016/0021211, cited above. In particular, small updates (which commonly occur in data such as price changes, inventory changes, or changes to the selection of items for the subset) can be sent incrementally, possibly embedded in the notification that informs the user device that changes are available for prefetch. In other embodiments, an update rate can be specified to set how often the data is updated (i.e., synchronized with server 24).

In some embodiments, the items that are supported by locally cached data in cache 48 (or possibly even preloaded and/or pre-rendered) are marked on the screen of user device 28 to indicate this fact. In this manner, the user is aware which items will provide a quick response when accessed.

The configurations of system 20, system 50 and their various elements, as shown in FIGS. 1 and 2, are example configurations that are chosen purely for the sake of conceptual clarity. In alternative embodiments, any other suitable configurations can be used. The different elements of systems 20 and/or 50 may be implemented using suitable software, using suitable hardware, e.g., using one or more Application-Specific Integrated Circuits (ASICs) or Field-Programmable Gate Arrays (FPGAs), or using a combination of hardware and software elements. Device cache 48 may be implemented using any suitable memory or storage device. In some embodiments, processors 42, and/or 68 are implemented using one or more general-purpose processors, which are programmed in software to carry out the functions described herein. The software may be downloaded to the processors in electronic form, over a network, for example, or it may, alternatively or additionally, be provided and/or stored on non-transitory tangible media, such as magnetic, optical, or electronic memory.

It will be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A user device, comprising:
an interface for communicating over a communication network with an electronic-commerce (“e-commerce”) server; and
a processor, configured to:
run within the user device a local instance of the e-commerce server, wherein the local instance (i) stores locally in the user device at least part of data available to the e-commerce server, and (ii) carries out locally in the user device at least part of a business logic of the e-commerce server; and
run an e-commerce agent, which conducts e-commerce transactions by interacting over the communication network with the e-commerce server, and locally with the local instance of the e-commerce server.

2. The user device according to claim 1, wherein the local instance is configured to carry out only part of the business logic of the e-commerce server, and to store locally only part of data available to the e-commerce server.

3. The user device according to claim 1, wherein the e-commerce agent is configured to conduct the e-commerce transactions by communicating with the local instance of the e-commerce server, and wherein the local instance is configured to communicate with the e-commerce server over the communication network when unable to respond locally to the e-commerce agent.

4. The user device according to claim 1, wherein the e-commerce agent is configured to conduct the e-commerce transactions by communicating with the local instance of the e-commerce server, and to communicate with the e-commerce server over the communication network when unable to obtain information needed for the e-commerce transactions locally from the local instance.

5. The user device according to claim 1, wherein the processor is further configured to run a prefetch agent that prefetches selected portions of the data and of the business logic, so as to synchronize the local instance with the e-commerce server.

6. The user device according to claim 5, wherein the prefetch agent is configured to receive from a network-side node a prefetch policy, and to prefetch the selected portions of the data and of the business logic in accordance with the prefetch policy.

7. The user device according to claim 1, wherein the local instance of the e-commerce server is configured to choose, in accordance with a selection criterion, a partial subset of the data or business logic for storing locally in the user device.

8. The user device according to claim 7, wherein the selection criterion chooses the partial subset of the data or business logic that (i) has a highest likelihood of being accessed, and (ii) does not exceed available resources of the user device.

9. The user device according to claim 8, wherein the likelihood is calculated across all user devices.

10. The user device according to claim 8, wherein the likelihood is calculated over a partial subset of all user devices.

11. The user device according to claim 7, wherein the local instance is configured to choose, for a given e-commerce item, how much of the data associated with the given e-commerce item to obtain from the e-commerce server.

12. The user device according to claim 1, wherein the processor is configured to conduct at least part of the e-commerce transactions in absence of a communication link with the e-commerce server.

13. The user device according to claim 1, wherein the e-commerce agent is configured to respond locally to a user search query, using the local instance.

14. The user device according to claim 13, wherein the processor is configured to contact the e-commerce server for obtaining supplemental information relating to a result of the search query.

15. The user device according to claim 1, wherein the local instance is configured to obtain, and store locally, one or more index files for performing user searches.

16. A system, comprising:
a user device, configured to run:
a local instance of an electronic-commerce (“e-commerce”) server, wherein the local instance (i) stores locally in the user device at least part of data available to the e-commerce server, and (ii) carries out locally in the user device at least part of a business logic of the e-commerce server; and
an e-commerce agent, which conducts e-commerce transactions by interacting over a communication network with the e-commerce server, and locally with the local instance of the e-commerce server; and
a prefetch control subsystem, configured to select portions of the data and of the business logic of the e-commerce server, and to prefetch the selected portions to the user device for use by the local instance of the e-commerce server.

17. The system according to claim 16, wherein the prefetch control subsystem is configured to provide a prefetch policy to the user device, and wherein the user device is configured to prefetch selected portions of the data and of the business logic in accordance with the prefetch policy.

18. The system according to claim 16, wherein the prefetch control subsystem is configured to cluster at least some e-commerce items of the e-commerce server into categories, and to assign to the e-commerce items respective access likelihood metrics per category, and wherein the user device is configured to conduct the e-commerce transactions in accordance with the access likelihood metrics.

19. A method, comprising:
running within a user device a local instance of an electronic-commerce (“e-commerce”) server, wherein the local instance (i) stores locally in the user device at least part of data available to the e-commerce server, and (ii) carries out locally in the user device at least part of a business logic of the e-commerce server; and
conducting in the user device e-commerce transactions, by running within the user device an e-commerce agent that interacts over a communication network with the e-commerce server, and locally with the local instance of the e-commerce server.

20. The method according to claim 19, wherein running the local instance comprises carrying out in the local instance only part of the business logic of the e-commerce server, and storing locally only part of data available to the e-commerce server.

21. The method according to claim 19, wherein running the e-commerce agent comprises conducting the e-commerce transactions by communicating with the local instance of the e-commerce server, and wherein running the local instance comprises communicating with the e-commerce server over the communication network when unable to respond locally to the e-commerce agent.

22. The method according to claim 19, wherein running the e-commerce agent comprises conducting the e-commerce transactions by communicating with the local instance of the e-commerce server, and communicating with the e-commerce server over the communication network when unable to obtain information needed for the e-commerce transactions locally from the local instance.

23. The method according to claim 19, and further comprising running within the user device a prefetch agent that prefetches selected portions of the data and of the business logic, so as to synchronize the local instance with the e-commerce server.

24. The method according to claim 23, wherein running the prefetch agent comprises receiving from a network-side node a prefetch policy, and prefetching the selected portions of the data and of the business logic in accordance with the prefetch policy.

25. The method according to claim 19, wherein running the local instance of the e-commerce server comprises choosing, in accordance with a selection criterion, a partial subset of the data or business logic for storing locally in the user device.

26. The method according to claim 25, wherein the selection criterion chooses the partial subset of the data or business logic that (i) has a highest likelihood of being accessed, and (ii) does not exceed available resources of the user device.

27. The method according to claim 26, and comprising calculating the likelihood across all user devices.

28. The user device according to claim 26, and comprising calculating the likelihood over a partial subset of all user devices.

29. The method according to claim 25, wherein running the local instance comprises choosing, for a given e-commerce item, how much of the data associated with the given e-commerce item to obtain from the e-commerce server.

30. The method according to claim 19, wherein conducting the e-commerce transactions comprises conducting at least part of the e-commerce transactions in absence of a communication link with the e-commerce server.

31. The method according to claim 19, wherein running the e-commerce agent comprises responding locally to a user search query, using the local instance.

32. The method according to claim 31, and comprising contacting the e-commerce server for obtaining supplemental information relating to a result of the search query.

33. The method according to claim 19, wherein running the local instance comprises obtaining, and storing locally, one or more index files for performing user searches.
